(19) United States
(12) Patent Application Publication
(10) Pub. No.: US 2026/0101980 A1
(43) Pub. Date: Apr. 16, 2026

(54) EARPHONE CASE AND EARPHONE KIT

(71) Applicant: Luxshare Precision Industry Company Limited, SHENZHEN (CN)

(72) Inventors: Shui Song Liu, SHENZHEN (CN); Heng Zhang, SHENZHEN (CN)

(73) Assignee: Luxshare Precision Industry Company Limited, SHENZHEN (CN)

(21) Appl. No.: 19/314,003

(22) Filed: Aug. 29, 2025

(30) Foreign Application Priority Data
Oct. 15, 2024 (CN) 202411441597.3

(51) Int. Cl. A45C 11/00; A45C 13/02; A45C 13/10; H04R 1/02; H04R 1/10

(52) U.S. Cl. CPC A45C 11/001; A45C 13/02; A45C 13/1069; H04R 1/02; H04R 1/1016

(57) ABSTRACT

An earphone case comprises an upper cover component having a sliding groove and a curved groove, and a lower shell component having a first sliding member located in the sliding groove, a second sliding member located in the curved groove and a resetting member connected with the first sliding member and the second sliding member. The curved groove is close to the sliding groove at first and second position, a center of the curved groove is far from that of the sliding groove. The resetting member is in a relaxed state at first or second position. When the upper cover component slides relative to the lower shell component, the first sliding member slides along the sliding groove, while the second sliding member slides along the curved groove.

### CLAIM OF PRIORITY AND CROSS-REFERENCE TO RELATED APPLICATION(S)

This application claims the benefit of Chinese Patent Application No. 202411441597.3, filed on Oct. 15, 2024, which is incorporated herein by reference in its entirety.

### BACKGROUND OF THE DISCLOSURE

### 1. Field of the Disclosure

The present disclosure relates to the field of wireless earphone, and particularly to an earphone case and an earphone kit.

### 2. Description of the Related Art

At present, the damping sense of the sliding cover mechanism of some earphone cases on the market during sliding is provided by magnets, which leads to a sense of pause during the sliding process and affects the user's experience.

### BRIEF DESCRIPTION OF THE DISCLOSURE

In view of this, the present disclosure provides an earphone case and an earphone kit, and balance the damping sense when an upper cover component slides by setting a resetting member between a first sliding member and a second sliding member.

On the first hand, the embodiment of the disclosure provides an earphone case, the earphone case comprises: an upper cover component, the upper cover component being formed with a sliding groove and a curved groove extending from a first position toward a second position, the curved groove being proximate to the sliding groove at the first position and the second position, with a center of the curved groove being distant from a center of the sliding groove; and a lower shell component, wherein an accommodating cavity is formed between the lower shell component and the upper cover component to accommodate earphones, the lower shell component having a first sliding member, a second sliding member and a resetting member, the first sliding member being located in the sliding groove, the second sliding member being located in the curved groove, and the resetting member connecting the first sliding member and the second sliding member respectively, the resetting member being in a relaxed state when at the first position or the second position; wherein the upper cover component is configured to slide relative to the lower shell component, causing the first sliding member to slide along the sliding groove and the second sliding member to slide along the curved groove.

In some embodiments, the sliding groove and the curved groove are each formed as an arch shape in a vertical plane.

In some embodiments, the curved groove has a first sidewall and a second sidewall, the first sidewall being located on a side proximate to the sliding groove, the second sidewall being located on a side distant from the sliding groove, and a height of the second sidewall being greater than a height of the first sidewall.

In some embodiments, a bottom of the sliding groove is provided with an elongated hole extending from the first position toward the second position; the first sliding member passes through the elongated hole to be disposed within the sliding groove.

In some embodiments, the first sliding member comprises: a connecting portion passing through the elongated hole; and a sliding portion located at a top end of the connecting portion and positioned within the sliding groove.

In some embodiments, the upper cover component is formed with two curved grooves, symmetrically distributed on two sides of the sliding groove; the lower shell component has two second sliding members and two resetting members, the two second sliding members being symmetrically distributed on two sides of the first sliding member, and the two resetting members being symmetrically distributed on two sides of the first sliding member and connected to corresponding second sliding members.

In some embodiments, the lower shell component is provided with a first magnet; the upper cover component is provided with a second magnet and a third magnet, the second magnet being located at the first position, the third magnet being located at the second position, and the upper cover component being configured to slide relative to the lower shell component to enable the second magnet or the third magnet to adsorb the first magnet.

In some embodiments, the upper cover component comprises a cover body and a first lining disposed within the cover body, the first lining being provided with the sliding groove and the curved groove on a side facing away from the lower shell component; the lower shell component comprises a shell body and a second lining disposed within the shell body, the second lining being provided with the first sliding member, the second sliding member and the resetting member.

In some embodiments, the first lining is configured as a dome-shaped structure.

In the second aspect, the embodiment of the disclosure also provides an earphone kit, the earphone kit includes: the earphone case as described in the first aspect; and earphones accommodated within the earphone case.

### BRIEF DESCRIPTION OF THE DRAWINGS

The above and other objectives, features, and advantages of the present disclosure will become clearer through the following description of embodiments of the present disclosure with reference to the accompanying drawings:

FIG. 1 is the structural diagram of a closed state of an earphone case provided by the embodiment of the disclosure;

FIG. 2 is the structural diagram of a open state of the earphone case provided by the embodiment of the disclosure;

FIG. 3 is a partial structural diagram of the closed state of the earphone case provided by the embodiment of the disclosure;

FIG. 4 is a partial structural diagram of the open state of the earphone case provided by the embodiment of the disclosure;

FIG. 5 is the explosion diagram of the earphone case provided by the embodiment of the disclosure;

FIG. 6 is the structural diagram of a first lining provided by the embodiment of the disclosure;

FIG. 7 is the structural diagram of another perspective of the first lining provided by the embodiment of the disclosure;

FIG. 8 is a sectional diagram of the closed state of the earphone case provided by the embodiment of the disclosure;

FIG. 9 is a sectional diagram of the open state of the earphone case provided by the embodiment of the disclosure;

FIG. 10 is the structural diagram of a first sliding member provided by the embodiment of the disclosure;

FIG. 11 is the structural diagram of a second sliding member provided by the embodiment of the disclosure.

### DETAILED DESCRIPTION OF EMBODIMENTS OF THE DISCLOSURE

The following describes the present application based on embodiments, but the present application is not limited to these embodiments. In the following detailed description of the present application, specific details are described in detail. For those skilled in the art, the present application may be fully understood without the description of these detailed parts. To avoid confusion of the essence of the present application, the well-known methods, processes, procedures, components, and circuits have not been described in detail.

In addition, ordinary technical personnel in this field should understand that the accompanying drawings provided here are for illustrative purposes and may not necessarily be drawn to scale.

Unless otherwise specified and limited, the terms “installation”, “connection”, “coupling”, “fixation”, etc. should be broadly understood, for example, they may be fixed connections, detachable connections, or integrated. It may be a mechanical connection or an electrical connection. It may be directly connected or indirectly connected through an intermediate medium, and may be a connection within two components or an interaction relationship between two components, unless otherwise specified. For ordinary technical personnel in this field, the specific meanings of the above terms in this application may be understood according to the specific situation.

For ease of explanation, spatial terms such as “inside”, “outside”, “lower”, “below”, “under”, “upper”, “above”, etc. are used here to describe the relationship between one element or feature illustrated in the figure and another element or feature. It will be understood that space related terms may imply different orientations of the device during use or operation, apart from those depicted in the diagram. For example, if the device in the figure is flipped, the component described as being “below” or “under” other components or features will then be positioned “above” that other component or feature. Therefore, the example term “below” may encompass both the directions above and below. The device may be oriented in other ways (rotated 90 degrees or in other orientations), and the spatial descriptors used here should be explained accordingly.

Unless explicitly required by the context, words such as “including” and “containing” in the entire application document should be interpreted as containing rather than exclusive or exhaustive. That is to say, it means “including but not limited to”.

In the description of this application, it should be understood that the terms “first”, “second”, etc. are only used for descriptive purposes and cannot be understood as indicating or implying relative importance. In addition, in the description of this application, unless otherwise specified, the meaning of “multiple”refers to two or more.

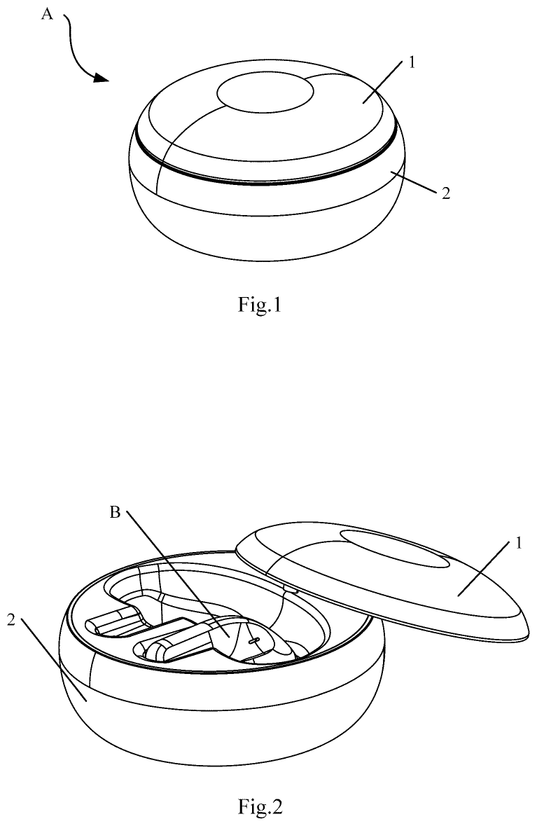

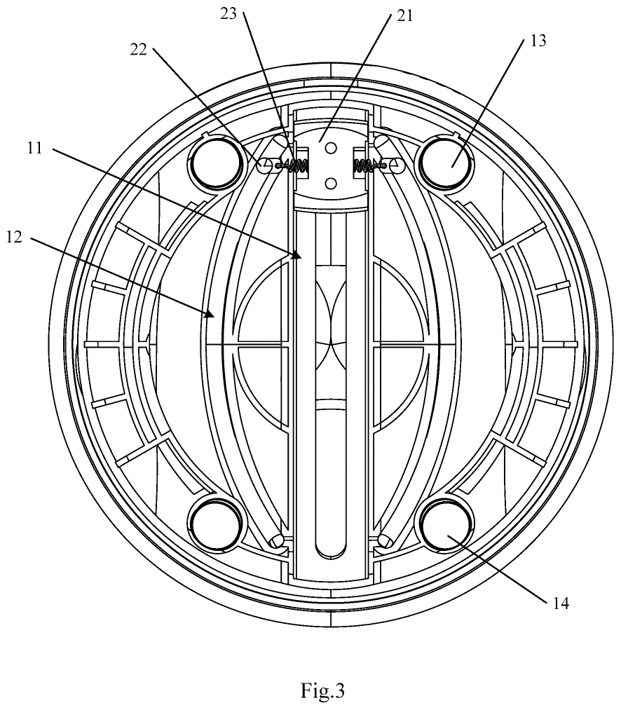

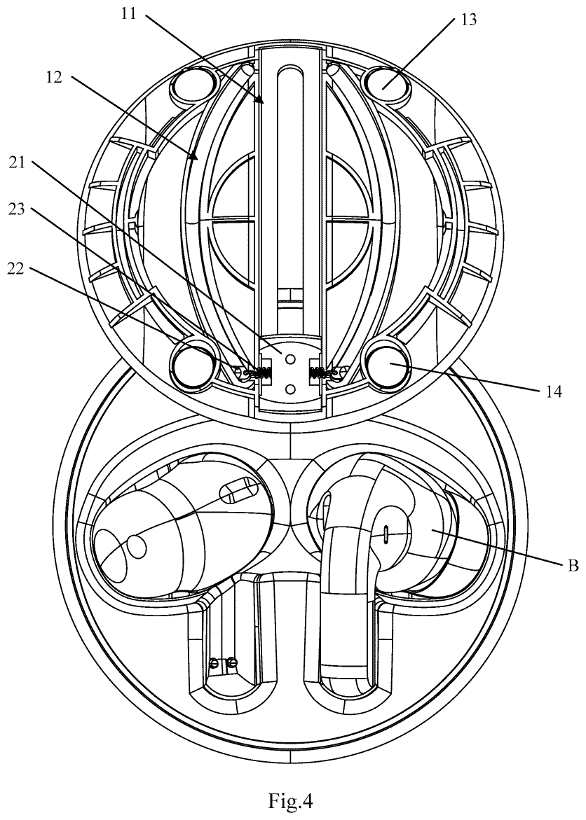

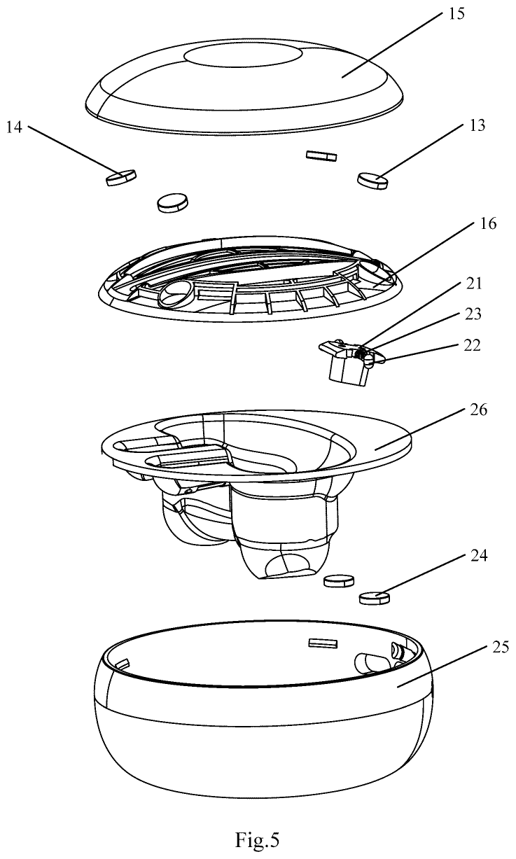

FIG. 1 is the structural diagram of a closed state of an earphone case provided by the embodiment of the disclosure, and FIG. 2 is the structural diagram of a open state of the earphone case provided by the embodiment of the disclosure. As shown in FIG. 1 and FIG. 2, the earphone case A includes an upper cover component 1 and a lower shell component 2. It is easy to understand that an accommodating cavity is formed between the upper cover component 1 and the lower shell component 2 to accommodate earphones B. Further, FIG. 3 is a partial structural diagram of the closed state of the earphone case provided by the embodiment of the disclosure, FIG. 4 is a partial structural diagram of the open state of the earphone case provided by the embodiment of the disclosure, and FIG. 5 is the explosion diagram of the earphone case provided by the embodiment of the disclosure. As shown in FIGS. 3 to 5, the upper cover component 1 extends from a first position to a second position to form a sliding groove 11 and a curved groove 12. It should be noted that the first position and the second position are two relative positions on the upper cover component 1. The curved groove 12 is close to the sliding groove 11 at the first position and the second position, and a center of the curved groove 12 is far away from a center of the sliding groove 11. That is to say, in the process of extending from the first position to the second position, the curved groove 12 gradually moves away from the sliding groove 11, and then moves closer to the sliding groove 11, thus forming an arch in a horizontal plane. Further, the lower shell component 2 has a first sliding member 21, a second sliding member 22, and a resetting member 23. Specifically, the first sliding member 21 is located in the sliding groove 11, the second sliding member 22 is located in the curved groove 12, and the resetting member 23 is respectively connected with the first sliding member 21 and the second sliding member 22. It is easy to understand that when the upper cover component 1 maintains its initial state, so that the first sliding member 21, the second sliding member 22 and the resetting member 23 are in the first position, the upper cover component 1 is in a closed state (see FIG. 3). Correspondingly, when the upper cover component 1 slides relative to the lower shell component 2 so that the first sliding member 21, the second sliding member 22 and the resetting member 23 are in the second position, the upper cover component 1 is in an open state (see FIG. 4).

It should be noted that the resetting member 23 is in a relaxed state at the first position or the second position. It is easy to understand that the resetting member 23 is in a tensile state when moving in an area between the first position and the second position. As an optional embodiment, the resetting member 23 is set as a spring, and both ends of the spring are respectively connected with the first sliding member 21 and the second sliding member 22. As another optional embodiment, the resetting member 23 is set as an elastic rubber or other elastic parts, that is, the elastic deformation produced by the resetting member 23 at the first position or the second position is the smallest. It should be further noted that in order to complete the operation of the switch cover, the upper cover component 1 is configured to slide relative to the lower shell component 2, so that the first sliding member 21 slides along the sliding groove 11, while the second sliding member 22 slides along the curved groove 12.

It is easy to understand that during the process of pushing the upper cover component 1 from the closed position to the open position, the first sliding member 21 slides along the sliding groove 11 from the first position to the second position relative to the upper cover component 1, thus driving the resetting member 23 to move from the first position to the second position, and then pulling the second sliding member 22 to slide along the curved groove 12 from the first position to the second position relative to the upper cover component 1. Since the curved groove 12 has a curved structure, in the above process, the resetting member 23 is gradually stretched from the relaxed state to provide a damping force, which may balance the instantaneous thrust generated when opening the cover, so that the cover may be opened smoothly. After the second sliding member 22 passes through the center of the curved groove 12, the resetting member 23 is gradually reset based on the elastic force to return to the relaxed state. As a result, the earphone case A may balance the sense of damping in the sliding process when opening the cover, thus enhancing the sliding feel to enhance the user's experience.

Correspondingly, when the upper cover component 1 is pushed from the open position to the closed position, the first sliding member 21 slides from the second position to the first position along the sliding groove 11 relative to the upper cover component 1, thus driving the resetting member 23 to move from the second position to the first position, and then pulling the second sliding member 22 to slide from the second position to the first position along the curved groove 12 relative to the upper cover component 1. Since the curved groove 12 has a curved structure, in the above process, the resetting member 23 is gradually stretched from the relaxed state to provide damping force. After the second sliding member 22 passes through the center of the curved groove 12, the resetting member 23 is gradually reset based on the elastic force to return to the relaxed state. The gradually increasing damping force provided by the resetting member 23 may balance the instantaneously increased thrust, so as to achieve smooth cover opening. As a result, the earphone case A may balance the damping sense in the sliding process when closing the cover, thus enhancing the sliding feel to enhance the user's experience.

As shown in FIG. 5, in one embodiment, the upper cover component 1 includes a cover body 15 and a first lining 16 arranged in the cover body 15. The sliding groove 11 and the curved groove 12 are arranged on the side of the first lining 16 away from the lower shell component 2. On the other hand, the lower shell component 2 comprises a shell body 25 and a second lining 26 arranged in the shell body 25, and the first sliding member 21, the second sliding member 22 and the resetting member 23 are arranged on the second lining 26. It is easy to understand that earphone case A may easily adjust the structure for earphones B through the first lining 16 and the second lining 26, thus helping to improve applicability and reduce costs.

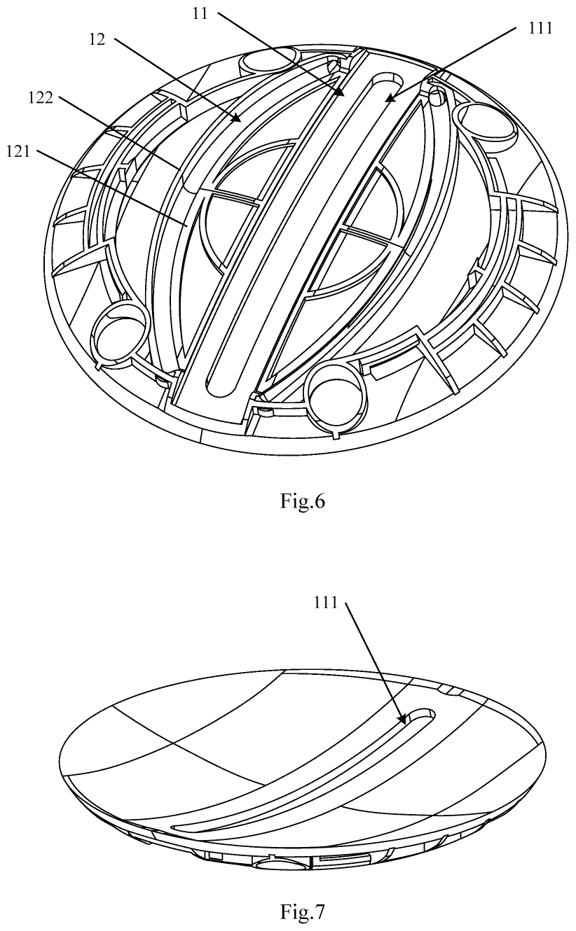

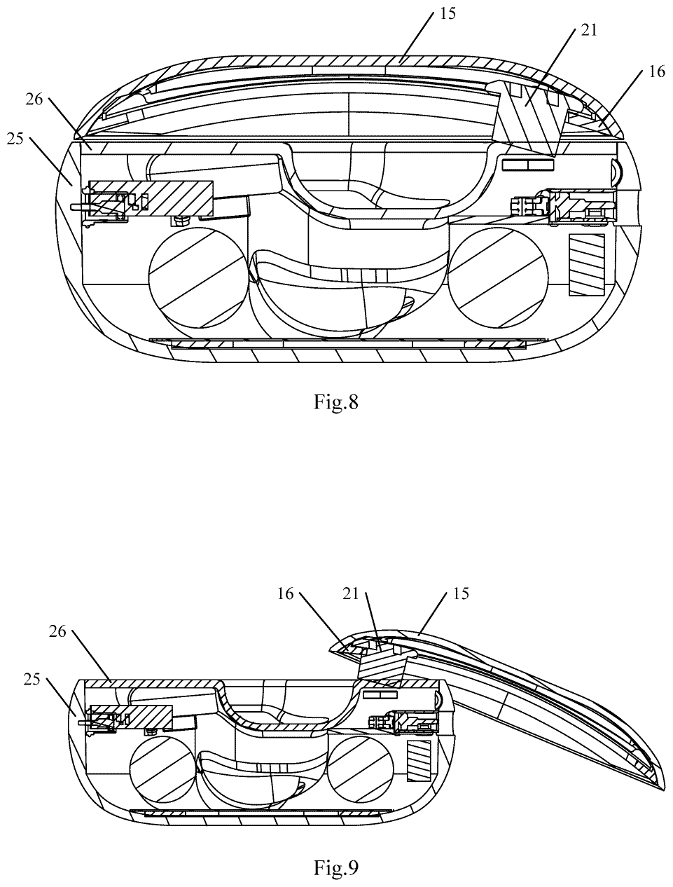

FIG. 6 is the structural diagram of a first lining provided by the embodiment of the disclosure, FIG. 7 is the structural diagram of another perspective of the first lining provided by the embodiment of the disclosure, FIG. 8 is a sectional diagram of the closed state of the earphone case provided by the embodiment of the disclosure, and FIG. 9 is a sectional diagram of the open state of the earphone case provided by the embodiment of the disclosure. In one embodiment, the sliding groove 11 and the curved groove 12 are arched in the vertical plane respectively, as shown in FIGS. 6 to 9. Thus, when the first sliding member 21 slides along the sliding groove 11 relative to the upper cover component 1, and the second sliding member 22 slides along the curved groove 12 relative to the upper cover component 1, the sliding paths of the first sliding member 21 and the second sliding member 22 in the vertical plane are arched. That is to say, when the upper cover component 1 is pushed to complete the operation of opening and closing the cover, the upper cover component 1 slides along the arch path to avoid interference with the earphones B placed in the earphone case A, so as to ensure that the upper cover component 1 may slide smoothly.

As shown in FIG. 7, in one embodiment, the first lining 16 is provided with a dome-shaped structure. Thus, the sliding groove 11 and the curved groove 12 may be adapted to the structure of the first lining 16 to form an arch in the vertical plane. Further, the bottom surface of the first lining 16 is set as a smooth curved surface, which helps to prevent the upper cover component 1 from bumping and damaging the earphones B, and may ensure that the upper cover component 1 may slide smoothly.

As shown in FIG. 6, in one embodiment, the curved groove 12 has a first sidewall 121 and a second sidewall 122. Specifically, the first sidewall 121 is located on the side close to the sliding groove 11, and the second sidewall 122 is located on the side far from the sliding groove 11. Further, a height of the second sidewall 122 is greater than a height of the first sidewall 121. Thus, the curved groove 12 may not only prevent the second sliding member 22 from derailing and other problems during the sliding process, but also reserve enough space for the resetting member 23 to install and move.

As shown in FIG. 6 and FIG. 7, in one embodiment, the bottom of sliding groove 11 is provided with an elongated hole 111. It is easy to understand that the elongated hole 111 extends from the first position of the upper cover component 1 towards the second position of the upper cover component 1. Further, the first sliding member 21 passes through the elongated hole 111 to be arranged in the sliding groove 11. It is easy to understand that when the first sliding member 21 slides along the sliding groove 11, the sliding groove 11 and the elongated hole 111 may simultaneously guide and limit the first sliding member 21.

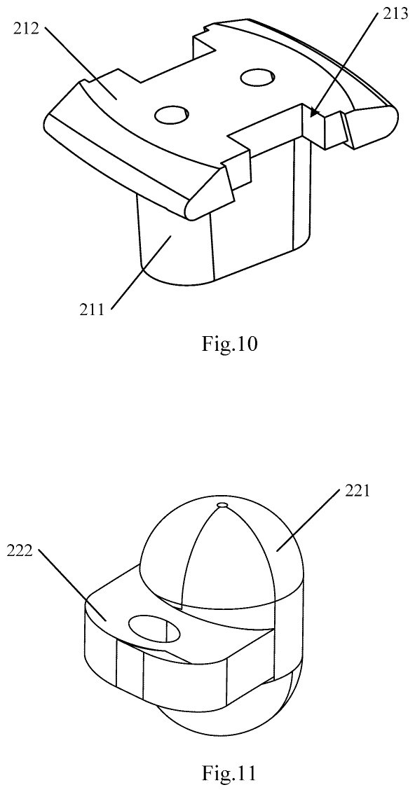

FIG. 10 is the structural diagram of a first sliding member provided by the embodiment of the disclosure. As shown in FIG. 10, in one embodiment, the first sliding member 21 includes a connecting portion 211 and a sliding portion 212. Specifically, the connecting portion 211 passes through the elongated hole 111, and the sliding portion 212 is located at a top of the connecting portion 211 and in the sliding groove 11. It is easy to understand that the connecting portion 211 matches with the elongated hole 111, and the sliding portion 212 matches with the sliding groove 11. Specifically, the connecting portion 211 is arranged in a symmetrical columnar structure, and the sliding portion 212 is arranged in a symmetrical flat structure. A cross sectional dimension of the connecting portion 211 is smaller than a cross sectional dimension of the sliding portion 212, thus preventing the first sliding member 21 from separating from the first lining 16 in the vertical direction, that is, preventing the upper cover component 1 from falling off. Optionally, the sliding portion 212 is provided with a notch 213, and the resetting member 23 is connected with the sliding portion 212 at the notch 213 to realize the connection with the first sliding member 21.

As shown in FIG. 3, FIG. 4 and FIG. 6, in one embodiment, the upper cover component 1 is formed with two curved grooves 12, and two curved grooves 12 are symmetrically distributed on both sides of sliding groove 11. Correspondingly, the lower shell component 2 has two second sliding members 22 and two resetting members 23. Further, two second sliding members 22 are symmetrically distributed on both sides of the first sliding member 21, and two resetting members 23 are symmetrically distributed on both sides of the first sliding member 21 and connected with the corresponding second sliding member 22. It is easy to understand that when the upper cover component 1 is pushed, the two second sliding members 22 may synchronously slide in their corresponding curved groove 12, and the two resetting members 23 may synchronously stretch or retract, which helps to balance the force on each component, thus making the sliding of the upper cover component 1 more smooth.

In one embodiment, the lower shell component 2 has a first magnet 24. Correspondingly, the upper cover component 1 has a second magnet 13 and a third magnet 14. Further, the second magnet 13 is located at the first position, and the third magnet 14 is located at the second position. Further, the upper cover component 1 is configured to slide relative to the lower shell component 2 so that the second magnet 13 or the third magnet 14 may adsorb the first magnet 24. Therefore, when the upper cover component 1 is in the closed position, the first magnet 24 and the second magnet 13 are adsorbed, thus ensuring the closing effect of the upper cover component 1. When the upper cover component 1 is in the open position, the first magnet 24 and the third magnet 14 are adsorbed to ensure the opening effect of the upper cover component 1. Optionally, the side of the first lining 16 away from the lower shell component 2 is provided with a plurality of slot structures, so that the second magnet 13 and the third magnet 14 may be positioned. In this embodiment, the lower shell component 2 has two first magnets 24 and the first magnets 24 are spaced on both sides of the first sliding member 21, the upper cover component 1 has two second magnets 13 and the second magnets 13 are spaced on both sides of the sliding groove 11, and the upper cover component 1 has two third magnets 14 and the third magnets 14 are spaced on both sides of the sliding groove 11, so that the stability of the adsorption structure may be guaranteed, and thus the switching effect of the upper cover component 1 may be guaranteed.

FIG. 11 is the structural diagram of a second sliding member provided by the embodiment of the disclosure. As shown in FIG. 11, in one embodiment, the second sliding member 22 includes a main body portion 221 and an extending portion 222 formed by the main body portion 221 extending toward the side. It is easy to understand that the end of the main body portion 221 is provided with a dome-shaped structure, and the main body portion 221 is arranged in the curved groove 12 to enable the second sliding member 22 to slide smoothly in the curved groove 12. Further, the extending portion 222 is configured to connect the resetting member 23. It should be noted that, corresponding to the arched curved groove 12 in the vertical plane, the extending portion 222 is arranged at an angle to move along the first sidewall 121 of the curved groove 12 when the second sliding member 22 slides.

The embodiment of the disclosure also provides an earphone kit, which includes an earphone case A and earphones B. It should be noted that the structure of the earphone case A is as described above, and will not be repeated here. Further, earphones B are accommodated in earphone case A. Therefore, when using the earphone kit, the user may open or close the upper cover component 1 in a sliding manner, and the sliding feel is good. In addition, the upper cover component 1 will not interfere with the earphones B, thus ensuring smooth opening and closing.

The embodiment of the disclosure provides an earphone case and an earphone kit, and the earphone case comprises an upper cover component and a lower shell component. The upper cover component extends from a first position to a second position to form a sliding groove and a curved groove. The curved groove is close to the sliding groove at the first position and the second position, and a center of the curved groove is far from a center of the sliding groove. The lower shell component is provided with a first sliding member, a second sliding member and a resetting member, the first sliding member is located in the sliding groove, the second sliding member is located in the curved groove, the resetting member is respectively connected with the first sliding member and the second sliding member, and the resetting member is in a relaxed state at the first position or the second position. When the upper cover component slides relative to the lower shell component, the first sliding member slides along the sliding groove, while the second sliding member slides along the curved groove. As a result, the earphone case may balance the thrust with damping force by setting a resetting member, which may ensure smooth switching and improve the feel when sliding.

The above description is only a preferred embodiment of the present application and is not intended to limit the present application. For those skilled in the art, the present application may have various modifications and variations. Any modifications, equivalent substitutions, improvements, etc. made within the spirit and principles of this application should be included within the scope of protection of this application.

I/We claim:

1. An earphone case, comprising:
an upper cover component (1), the upper cover component (1) being formed with a sliding groove (11) and a curved groove (12) extending from a first position toward a second position, the curved groove (12) being proximate to the sliding groove (11) at the first position and the second position, with a center of the curved groove (12) being distant from a center of the sliding groove (11); and
a lower shell component (2), wherein an accommodating cavity is formed between the lower shell component (2) and the upper cover component (1) to accommodate earphones (B), the lower shell component (2) having a first sliding member (21), a second sliding member (22) and a resetting member (23), the first sliding member (21) being located in the sliding groove (11), the second sliding member (22) being located in the curved groove (12), and the resetting member (23) connecting the first sliding member (21) and the second sliding member (22) respectively, the resetting member (23) being in a relaxed state when at the first position or the second position;
wherein the upper cover component (1) is configured to slide relative to the lower shell component (2), causing the first sliding member (21) to slide along the sliding groove (11) and the second sliding member (22) to slide along the curved groove (12).

2. The earphone case according to claim 1, wherein the sliding groove (11) and the curved groove (12) are each formed as an arch shape in a vertical plane.

3. The earphone case according to claim 1, wherein the curved groove (12) has a first sidewall (121) and a second sidewall (122), the first sidewall (121) being located on a side proximate to the sliding groove (11), the second sidewall (122) being located on a side distant from the sliding groove (11), and a height of the second sidewall (122) being greater than a height of the first sidewall (121).

4. The earphone case according to claim 1, wherein a bottom of the sliding groove (11) is provided with an elongated hole (111) extending from the first position toward the second position;
the first sliding member (21) passes through the elongated hole (111) to be disposed within the sliding groove (11).

5. The earphone case according to claim 4, wherein the first sliding member (21) comprises:
a connecting portion (211) passing through the elongated hole (111); and
a sliding portion (212) located at a top end of the connecting portion (211) and positioned within the sliding groove (11).

6. The earphone case according to claim 5, wherein the connecting portion (211) is arranged in a symmetrical columnar structure, the sliding portion (212) is arranged in a symmetrical flat structure, and a cross sectional dimension of the connecting portion (211) is smaller than a cross sectional dimension of the sliding portion (212).

7. The earphone case according to claim 6, wherein the sliding portion (212) is provided with a notch (213), and the resetting member (23) is connected with the sliding portion (212) at the notch (213).

8. The earphone case according to claim 1, wherein the upper cover component (1) is formed with two curved grooves (12), symmetrically distributed on two sides of the sliding groove (11);
the lower shell component (2) has two second sliding members (22) and two resetting members (23), the two second sliding members (22) being symmetrically distributed on two sides of the first sliding member (21), and the two resetting members (23) being symmetrically distributed on two sides of the first sliding member (21) and connected to corresponding second sliding members (22).

9. The earphone case according to claim 1, wherein the lower shell component (2) is provided with a first magnet (24);
the upper cover component (1) is provided with a second magnet (13) and a third magnet (14) the second magnet (13) being located at the first position, the third magnet (14) being located at the second position, and the upper cover component (1) being configured to slide relative to the lower shell component (2) to enable the second magnet (13) or the third magnet (14) to adsorb the first magnet (24).

10. The earphone case according to claim 9, wherein the lower shell component (2) has two first magnets (24) and the first magnets (24) are spaced on both sides of the first sliding member (21), the upper cover component (1) has two second magnets (13) and the second magnets (13) are spaced on both sides of the sliding groove (11), and the upper cover component (1) has two third magnets (14) and the third magnets (14) are spaced on both sides of the sliding groove (11).

11. The earphone case according to claim 1, wherein the second sliding member (22) includes a main body portion (221) and an extending portion (222) formed by the main body portion (221) extending toward the side, the main body portion (221) is arranged in the curved groove (12), the extending portion (222) is configured to connect the resetting member (23).

12. The earphone case according to claim 1, wherein the upper cover component (1) comprises a cover body (15) and a first lining (16) disposed within the cover body (15), the first lining (16) being provided with the sliding groove (11) and the curved groove (12) on a side facing away from the lower shell component (2).

13. The earphone case according to claim 12, wherein the first lining (16) is configured as a dome-shaped structure.

14. The earphone case according to claim 12, wherein the bottom surface of the first lining (16) is set as a smooth curved surface.

15. The earphone case according to claim 12, wherein the lower shell component (2) comprises a shell body (25) and a second lining (26) disposed within the shell body (25), the second lining (26) being provided with the first sliding member (21), the second sliding member (22) and the resetting member (23).

16. An earphone kit, comprising:
the earphone case (A) according to claim 1; and
earphones (B) accommodated within the earphone case (A).

17. The earphone kit according to claim 16, wherein the sliding groove (11) and the curved groove (12) are each formed as an arch shape in a vertical plane.

18. The earphone kit according to claim 16, wherein a bottom of the sliding groove (11) is provided with an elongated hole (111) extending from the first position toward the second position;
the first sliding member (21) passes through the elongated hole (111) to be disposed within the sliding groove (11).

19. The earphone kit according to claim 18, wherein the first sliding member (21) comprises:
a connecting portion (211) passing through the elongated hole (111); and
a sliding portion (212) located at a top end of the connecting portion (211) and positioned within the sliding groove (11).

20. The earphone kit according to claim 16, wherein the lower shell component (2) is provided with a first magnet (24);
the upper cover component (1) is provided with a second magnet (13) and a third magnet (14), the second magnet (13) being located at the first position, the third magnet (14) being located at the second position, and the upper cover component (1) being configured to slide relative to the lower shell component (2) to enable the second magnet (13) or the third magnet (14) to adsorb the first magnet (24).
